(19) United States
(12) Patent Application Publication
(10) Pub. No.: US 2006/0082839 A1
(43) Pub. Date: Apr. 20, 2006

(54) System for processing image signals from an image scanner having a platen and a document handler

(75) Inventors: John Alan Durbin, Webster, NY (US); Eric John Le Sueur, Middlesex (GB)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/966,237

(22) Filed: Oct. 15, 2004

(51) Int. Cl. H04N 1/04

(52) U.S. Cl. 358/474

(57) ABSTRACT

In a document scanner wherein a scanner bar can record images from either a platen or a document handler, a control system ensures that characteristics of the video from the scanner bar are consistent whether the images are recorded from the platen or the document handler. A calibration method includes passing a test sheet through the document handler and placing it on the platen, and then deriving a correction factor based on the resulting readings.

### TECHNICAL FIELD

The present disclosure relates to a system for processing image signals from an image scanner, as would be found, for example, in a digital copier.

### BACKGROUND

Document handlers are devices which draw individual sheets from a stack of sheets, and sequentially allow the image on each sheet to be recorded, typically by a photosensitive device in a digital copier, scanner, or facsimile. In a common arrangement, a copier has a conventional main platen, on which single sheets can be manually placed, as well as a smaller platen, typically adjacent the main platen, which is used by the document handler when sheets are being passed therethrough. In a typical design, when a single sheet is being recorded through the main platen, the photosensitive device is moved relative to the platen to record the entire image; when the document handler is being used to expose images through the smaller platen, a photosensitive device is typically left stationary under the smaller platen, and the motion of the sheet caused by the hardware within the document handler provides the necessary relative motion of each sheet past the photosensitive device.

The present disclosure relates to a system by which the characteristics of a video output from a photosensitive device can be controlled whether the photosensitive device is recording an image either from the document handler or through the platen.

### PRIOR ART

U.S. Pat. No. 5,621,217 discloses a calibration method for an input scanner. A calibration strip have reference information printed thereon is mounted inside the scanner, where it can be occasionally scanned.

U.S. Pat. No. 6,038,038 discloses a calibration method for setting a gain and offset control for a scanner.

U.S. Pat. No. 6,330,083 discloses a scanner having both a platen and a document handler. A system, described at column 20 thereof, takes into account degradation of a light source after a number of sheets are exposed through the document handler.

U.S. Pat. No. 6,576,883 discloses signal and gain control in a flatbed scanner, in which a scan head moves relative to an image on a platen.

### SUMMARY

According to one aspect, there is provided a method of operating an input scanner, the input scanner including a platen, a document handler, and a scanner bar for recording image data from a sheet on the platen and a sheet passing through the document handler, comprising recording image data from a sheet through the platen, and recording image data from the sheet through the document handler. A video output from the scanner bar is adjusted so that a video output from the scanner bar through the document handler is equal to a video output from the scanner bar through the platen.

### BRIEF DESCRIPTION OF THE DRAWING

FIG. 1 is an elevational view of a document handler in combination with a scanner or copier.

### DETAILED DESCRIPTION

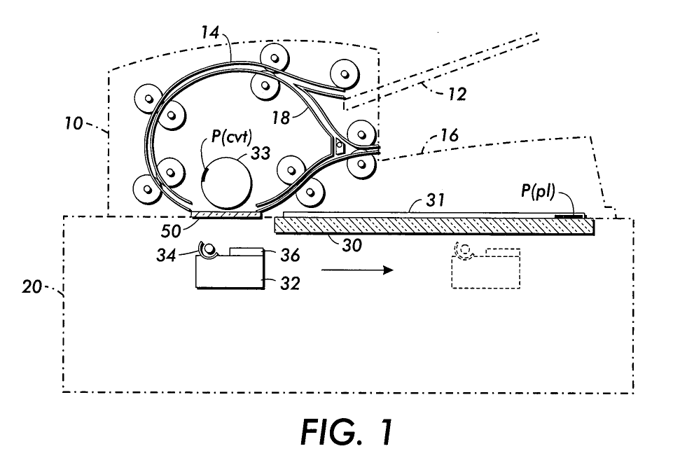

FIG. 1 is an elevational view of a document handler in combination with a scanner or copier. The document handler, generally indicated as 10 (which is also known as a “constant-velocity transport,” or CVT), sits atop a main body 20 of the scanner or copier. As is common in office equipment, the document handler 10 is positionable or movable relative to the main body 20, typically by a pivot or hinge-like mechanism (not shown) at the back of the scanner. Further as is common, when the document handler 10 is moved away form the main body 20, a main platen 30 is in effect exposed to the user, so that the user can place a single sheet to have an image thereon recorded. When the document handler 10 is in the closed position, a platen backing 31 is in contact with main platen 30 and faces downward.

Underneath main platen 30, in this embodiment, is what is here called a scanner bar 32. Mounted on scanner bar 32 is a light source 34 and a photosensor array 36, which are arranged so that light emitted by light source 34 is reflected by an image disposed over main platen 30, and the reflected light is recorded by an image receptor, which in this embodiment is a photosensor array 36. Photosensor array 36 typically includes one or more photosensitive chips, and is connected to image processing circuitry downstream (not shown), to record image data in a manner familiar in the art. When a single sheet or other item is desired to be recorded, the scanner bar 32 is caused to move, as shown, relative to the main platen 30 to record an entire image on main platen 30. In an alternate embodiment of the apparatus, photosensor array 36 is largely stationary within main body 20, but can selectively record an image on platen 30 or through document handler 10 by the action of an arrangement of one or more movable mirrors or lenses (not shown).

When the document handler 10 is used to record images on one or more sheets, the sheets are placed in input tray 12, and are drawn one at a time through path 14 (by one or more motors, not shown, driving the rollers along path 14) past scanner bar 32 and ultimately to an output tray 16. If a document handler 10 is capable of “duplexing,” that is, sequentially scanning first one side and then the other side of a sheet, the sheet is effectively inverted and passed through duplexing path 18 for scanning of the second side, in a manner generally familiar in the art. When the document handler 10 is used, scanner bar 32 remains stationary relative to the main body 20, and successive sheets are moved therepast through path 14. As used herein, when the document handler 10 is used to expose a series of sheets to the stationary scanner bar 32, it is said that images are read through the document handler 10. When there is no sheet passing through document handler 10, the scanner bar 32 “sees” a backer bar 33 within document handler 10. Backer bar 33 may be in the form of a rotatable roll, as shown, which helps in moving a sheet through document handler 10.

In a practical implementation of a scanner such as shown in the Figure, scanner bar 32, along with its light source 34, is used for recording both images on a sheet placed on platen 30 and a sheet passing through document handler 10. In this embodiment, there is further provided two test patches, which are placed in locations where they can respectively be read by scanner bar 32 either through the platen (patch P(pl)) or through the document handler 10 (P(cvt)). As is generally known in the art, these test-patches are areas of predetermined reflectivity which are placed in postions, such as on backing surface 31 or on or near backer bar 33, where they may be read by the scanner bar 32 in a calibration step. These test-patch readings, which may take place from time to time in the operation of the scanner, are respectively used to derive “Automatic Gain Control” or AGC algorithms, or specific values used therein, which are used to keep the output of the scanner bar 32 stable over time, whether the scanner bar is reading through the platen 30, which would be with an algorithm or value AGC(platen) or through document handler 10, which would be with an algorithm or value AGC(cvt). This corrects for any drift in the system with time such as a change in brightness of the lamp 34.

In practice, the scanning conditions between the platen 30 and document handler 10 may be significantly different at various times: for instance, if the backer bar 33 within document handler 10 becomes progressively dirty, when the backer bar 33 itself is used as a reference, a calibration operation will be distorted by the dirty backer bar. Further, a difference in the reflectivity between platen backer 31, which faces downward through platen 30, and backer bar 33, will result in different calibration results if those surfaces are used for calibration. It is desirable that the “video” (at least one attribute of the output signals, such as offset or gain, or a characteristic of a tone reproduction curve) of signals is the same when the scanner bar 32 is used with either document handler 10 or platen 30.

To overcome this practical problem, a calibration method comprises passing a sheet (or two sheets with the same reflectivity) through the document handler 10 for exposure there, and also (the order does not matter) placing the sheet on the platen 30 for exposure there. The exposures, or readings, are then used for calibration of signals from scanner bar 32.

In a basic case, as known in the prior art, the video is controlled with the following control algorithm:
V^{N′}(cvt)=[AGC(Platen)/AGC(cvt)*V^{O}(cvt) (1)
where V^{N}(cvt) is the new video computed for the CVT (document handler 10) after an automatic gain control (AGC) operation corrects for time video variation. V^{O}(cvt) is the original video at the CVT before it was operated on by the AGC. AGC(Platen) and AGC(cvt) are the AGC values or algorithms at the platen and CVT, based on readings from patches P(pl) and P(cvt) respectively.

As used herein, the “video” is nominally the signal from the reflected light intensity from a given target (a calibration sheet, or an image being scanned), expressed as a value proportional to the reflected light level. A light signal gets converted to a voltage by the photosensors in array 36 and then converted to a digital level in an A to D converter. In one embodiment, the video is a value 10 bits deep, but is then calibrated and in the process gets reduced to 8 bits. AGC can be defined as a function (an algorithm, or the values of one or more constants associated with the algorithm) relating to an adjustment to the gain to compensate for any variation with time.

According to the present embodiment, to make sure the video from scanner bar 32 at document handler 10 is equal to the video from scanner bar 32 at platen 30 over time and space, a prime video is defined thus:
V^{N′}(cvt)=[V(platen)/V^{O}(cvt)*V^{O}(cvt) (2)
where V^{N′}(cvt) is the new prime video at the CVT after correction for time and space variation. V(platen) is the video at the platen center. V^{O}(cvt) is the video before correction at the CVT. The correction factor is the ratio of the new prime video, equation (2), to the new video, equation (1):
Correction factor=V^{N′}(cvt)/V^{N}(cvt) (3)
Inserting equations (1) and (2) into equation (3) gives:
Correction factor=[V(platen)/V^{O}(cvt)*[AGC(cvt)/AGC(platen)] (4)

The video calculated at equation (1) is multiplied by this correction factor from equation (4) to get the new prime video, thus modifying the video output by scanner bar 32 through document handler 10. The correction factor ensures that the document handler 10 and the platen 30 have the same video for the same density document even if the video output from scanner bar 32 varies over time and space. In other words, while the individual AGC controls are suitable for correction within each of the platen and document handler, the correction factor in Equation 4 ensures that the video through the document handler 10 will be equal to the video through the platen 30.

To implement the use of the correction factor in equation (4), the same largely white test document (or, equivalently, two documents known to have the same reflectivity) is exposed to scanner bar 32 through the document handler 10 and also on the platen 30. A control system measures the AGC-controlled video values as well as the video at the document handler 10 and at the center of platen 30. This technique provides a robust method for ensuring that the scanning outputs at document handler 10 and on the platen 30 have equal video characteristics, even with different reflective backings due to a dirty backer bar 33 or platen cover 31; different energy outputs from the lamp 34 at the platen center and an AGC measurement location; different across-scan profiles at document handler 10 and on the platen 30; and other differences. In addition, a service engineer can be provided with a facility to update the correction factor after the machine has been running for some time when these ratios and the illumination profile will probably have changed.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

1. A method of operating an input scanner, the input scanner including a platen, a document handler, and a scanner bar for recording image data from a sheet on the platen and a sheet passing through the document handler, comprising:
recording image data from a sheet through the platen;
recording image data from the sheet through the document handler; and
adjusting a video output from the scanner bar so that a video output from the scanner bar through the document handler is equal to a video output from the scanner bar through the platen.

2. The method of claim 1, the adjusting including modifying the video output from the scanner bar using a correction factor.

3. The method of claim 2, the correction factor being derived at least partly from an AGC value associated with one of the platen and the document handler.

4. The method of claim 2, the correction factor being derived at least partly from an AGC value associated with each of the platen and the document handler.

5. The method of claim 3, the AGC value associated with the platen being derived from reading a test patch associated with the platen.

6. The method of claim 3, the AGC value associated with the document handler being derived from reading a test patch associated with the document handler.

7. The method of claim 1, wherein the sheet is largely white.
